(19) United States
(12) Patent Application Publication
(10) Pub. No.: US 2007/0045457 A1
(43) Pub. Date: Mar. 1, 2007

(54) Hammer tip and hammer using the hammer tip

(76) Inventor: Jeffrey T. Hickey, Bedford, PA (US)

Correspondence Address: KENNAMETAL INC., P.O. BOX 231, 1600 TECHNOLOGY WAY, LATROBE, PA, 15650, US

(21) Appl. No.: 11/213,223

(22) Filed: Aug. 26, 2005

(51) Int. Cl. B02C 13/00

(52) U.S. Cl. 241/195

(57) ABSTRACT

A hammer tip that is used in conjunction with a hammer. The hammer tip includes a hammer tip body that has a wear-resistant top surface and a bottom surface. The hammer tip body contains a hammer tip recess opening in the bottom surface. The hammer tip further includes a receptor, which contains a receptor bore. The receptor is affixed within the hammer tip recess.

### BACKGROUND OF THE INVENTION

The invention pertains to a hammer tip for use with a hammer, as well as the hammer that uses the hammer tip. More specifically, the invention pertains to an improved hammer tip for use with a hammer, as well as the hammer that uses the improved hammer tip.

There exist industrial equipment such as, for example, rotary hammermills, tub grinders, vertical feeders, horizontal feeders, and the like, that are used to reduce the size of any one of a wide variety of materials. For example, U.S. Pat. No. 5,386,947 to Omann discloses a hammermill used to reduce shingle material, which is a highly abrasive material. U.S. Pat. No. 4,033,515 to Barcell et al. shows an apparatus that uses a hammermill to separate adhered paper for a paper-covered gypsum board. U.S. Pat. No. 5,421,528 to Ronning discloses a hammermill used to process vegetative crops. U.S. Pat. No. 5,598,981 to Hellmich shows a hammermill used for the fragmentation of car bodies.

Very generally speaking, a hammermill or a like machine includes a drum or the like to which are attached hammers. Upon the rotation of the drum, the hammers also rotate so as to move in such a fashion to impinge upon the material to be reduced in size. In some instances, the hammer has a detachable hammer tip wherein the hammer tip presents a wear-resistant surface that actually impinges the material.

The hammers and the hammer tips experience a great deal of stress due to the frequent and violent contact between the hammer and the material wherein some types of material can be very abrasive such as, for example, shingles. Such contact typically causes premature wear of the hammer, and especially, premature wear of the bolt-nut assemblies that in some cases fasten the hammer tip to the hammer. In this regard, a hammer like that illustrated in U.S. Pat. No. 6,131,838 to Balvanz et al. (as well as U.S. Pat. No. 6,481,654 to Balvanz et al.) uses a pair of threaded bolts and their corresponding nuts to secure the hammer tip to the hammer. Both the bolt heads and the nuts can experience extreme wear due to the impingement of the material thereon. Extreme wear of the bolts and/or nuts that fasten the hammer tip to the hammer can lead to their premature failure which, in turn, can result in the hammer tip being thrown into the machine. Another hammer that uses a hammer tip is shown in U.S. Pat. No. 6,494,394 to Balvanz et al.

While it is possible to use a hammer that has a hammer tip permanently affixed thereto, there are drawbacks to this kind of arrangement. This is especially the case in light of the fact that, generally speaking, the hammer tip wears out before the hammer body wears out. There is an advantage in replacing only the hammer tip because in general the hammer tip is less expensive than the entire hammer that includes a hammer tip. In many instances, the replacement of only the hammer tip also takes less time to accomplish than the replacement of the entire hammer. By using a hammer that uses a detachable hammer tip, there is a decrease in the overall component expense and the labor expense as compared to a hammer that uses a permanently affixed hammer tip.

It would therefore be very desirable to provide an improved hammer tip, as well as a hammer that uses the hammer tip. It would also be very desirable to provide an improved detachable hammer tip, as well as a hammer that uses such a hammer tip. It would also be very desirable to provide an improved hammer tip, as well as a hammer that uses the hammer tip, wherein the structure that secures the hammer tip to the hammer is protected from wear due to the impingement of the material.

### SUMMARY OF THE INVENTION

In one form thereof, the invention is a hammer tip that is used in conjunction with a hammer. The hammer tip includes a hammer tip body that has a wear-resistant top surface and a bottom surface. The hammer tip body contains a hammer tip recess opening in the bottom surface. The hammer tip further includes a receptor, which contains a receptor bore. The receptor is affixed within the hammer tip recess.

In still another form thereof, the invention is a hammer tip for use in conjunction with a hammer. The hammer tip comprises a cast hammer tip body that has a top surface and a bottom surface. The cast hammer tip body has a wear-resistant portion beginning at and extending toward the bottom surface. The cast hammer tip body has a cast recess opening in the bottom surface. The hammer tip has a receptor that contains a receptor bore. A threaded member is received within the receptor bore. The receptor is within the hammer tip recess whereby at least a portion of the threaded member projects past the bottom surface of the hammer tip body.

In yet another form thereof, the invention is a hammer that includes a hammer body and a hammer tip. The hammer body contains a mounting surface and a bore in communication with the mounting surface. The hammer tip comprises a hammer tip body that has a wear-resistant top surface and a bottom surface wherein the bottom surface is adjacent to the mounting surface of the hammer body. The hammer tip body contains a hammer tip recess opening in the bottom surface. There is a receptor that contains a receptor bore. The receptor is affixed within the hammer tip recess. A threaded member passes through the bore in the hammer body and is received by the receptor bore so as to attach the hammer tip to the hammer body.

In still another form thereof, the invention is a hammer tip for use in conjunction with a hammer. The hammer tip comprises a wear-resistant top surface and a bottom surface. The bottom surface contains a threaded bore adapted to receive a threaded member.

### BRIEF DESCRIPTION OF THE DRAWINGS

The following is a brief description of the drawings that form a part of this patent application:

FIG. 1 is an isometric view of a specific embodiment of a hammer of the invention with a portion of the hammer body broken away so as to expose the connection between the receptor and the hammer body and the connection between the receptor and the threaded bolt;

FIG. 2 is a side view of the specific embodiment of the hammer tip of FIG. 1 with the threaded bolts removed and a portion of the hammer bit body broken away so as to show the geometry of the recesses without the receptors affixed with the recesses;

FIG. 3A is a side view of the threaded bolt that is received by the receptor;

FIG. 3B is a side view of the receptor;

FIG. 3C is a side view of the assembly of the receptor and the threaded bolt;

FIG. 4 is a bottom view of the hammer tip with the receptors affixed to the hammer tip body and with the threaded bolts removed;

FIG. 5 is a side view of the specific embodiment of the hammer tip of FIG. 1 with a portion of the hammer tip body broken away so show the receptors affixed in the recesses of the hammer tip body and threaded bolts received by the receptors;

FIG. 6 is a side view of a hammer wherein a portion of the hammer body is broken away so show the connection between the hammer tip (i.e., the specific embodiment of the hammer tip of FIG. 1) and the hammer; and

FIG. 7 is an isometric view of a second specific embodiment of the hammer tip showing a generally rectangular cast-in recess contained in the bottom surface with a generally rectangular receptor exploded away from the recess and the threaded members exploded away from the receptor;

FIG. 8 is an isometric view of a third specific embodiment of the hammer tip showing a generally rectangular cast-in recess contained in the bottom surface and integral flanges extending in a rearward direction from the longitudinal edges of the hammer tip, and with a generally rectangular receptor exploded away from the recess and the threaded members exploded away from the receptor;

FIG. 9 is a top plan view of a fourth specific embodiment of the hammer tip wherein the hammer tip has a integral flange extending in a rearward direction from the longitudinal edges of the hammer tip, and a pair of cast-in cylindrical recesses, each of which receives a receptor with a threaded bore, and the hammer tip is securely attached to the hammer via a pair of threaded members that are received in the threaded bores of the receptors in such a fashion so that the hammer tip is drawn tightly against the hammer;

FIG. 10 is an isometric view of a fourth specific embodiment of the hammer tip that has a hammer tip body with a wear-resistant insert affixed to the forward (or top) surface thereof and a pair of threaded bores contained in the rearward or bottom surface of the hammer tip with the threaded members exploded away from the threaded bores; and

FIG. 11 is an isometric view of a fifth specific embodiment of the hammer tip body that has integral flanges extending in a rearward direction from the longitudinal edges of the hammer tip and a wear-resistant insert affixed to the forward (or top) surface of the hammer tip body and a pair of threaded bores are contained in the rearward (or bottom) surface of the hammer tip with the threaded members exploded away from the threaded bores.

### DETAILED DESCRIPTION OF THE INVENTION

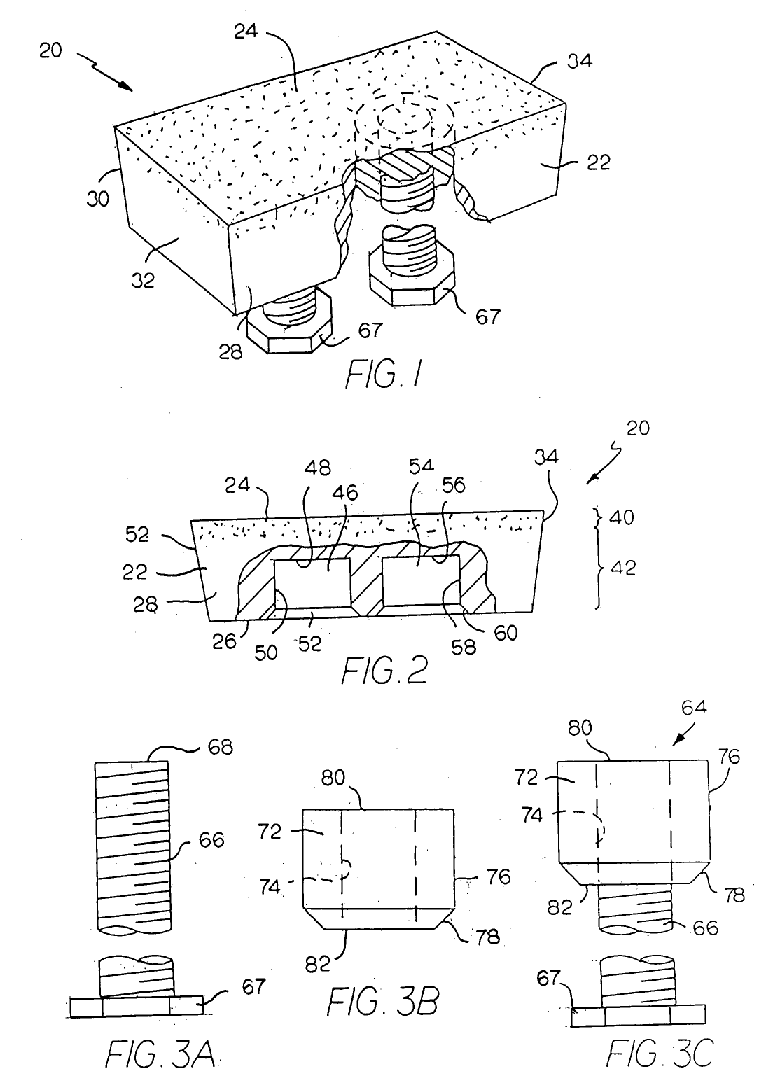

Referring to the drawings, FIG. 1 illustrates a specific embodiment of a hammer tip generally designated as 20. Hammer tip 20 has a body 22, which preferably is cast. Hammer tip body 22 has a wear-resistant top surface 24, an opposite bottom surface 26, a pair of opposite side surfaces 28 and 30 and a pair of opposite edge surfaces 32 and 34.

As shown in particular in FIG. 2, the hammer tip body 22 has a wear-resistant portion shown by bracket 40. This wear-resistant portion 40 begins at the top surface 24 and extends toward the bottom surface 26 a selected distance so as to make the wear-resistant portion 40 exhibit a selected thickness.

Although it is preferred to cast the hammer tip body 22, the hammer tip body 22 does not have to be cast so that the top surface could have a wear-resistant coating applied thereto. In this regard and as will be described in more detail hereinafter, the fourth specific embodiment shows a wear-resistant member affixed to the forward surface of the hammer tip body. However, in the preferred case, the hammer tip body 22 is typically cast according to the disclosure as set forth in U.S. Pat. No. 4,608,318 to Makrides et al. wherein this patent is hereby incorporated by reference herein.

As shown in FIG. 2, the wear-resistant portion 40 terminates a selected distance from the top surface 24. The balance of the hammer tip body 22 can be considered a support portion, which is designated by bracket 42 (see FIG. 2).

Still referring to FIG. 2, the hammer tip body 22 further contains a pair of cast-in recesses (or bores) that open in the bottom surface 26. One recess 46 has a bottom surface 48, a cylindrical side surface 50 and a frusto-conical mouth 52. The other recess 54 has a bottom surface 56, a cylindrical side surface 58 and a frusto-conical mouth 60.

Referring to FIGS. 3A, 3B and 3C, the hammer tip 20 further includes a receptor assembly generally designated as 64. Receptor assembly 64 includes a threaded member (or bolt) 66 that has a head 67 at one end and an opposite distal end 68. The receptor assembly 64 further includes a receptor 72 that contains a threaded bore 74. The receptor 72 also has a cylindrical side surface 76, a bottom surface 80 and a top surface 82. There is a chamfer 78 at the juncture of the cylindrical side surface 76 and the top surface 82.

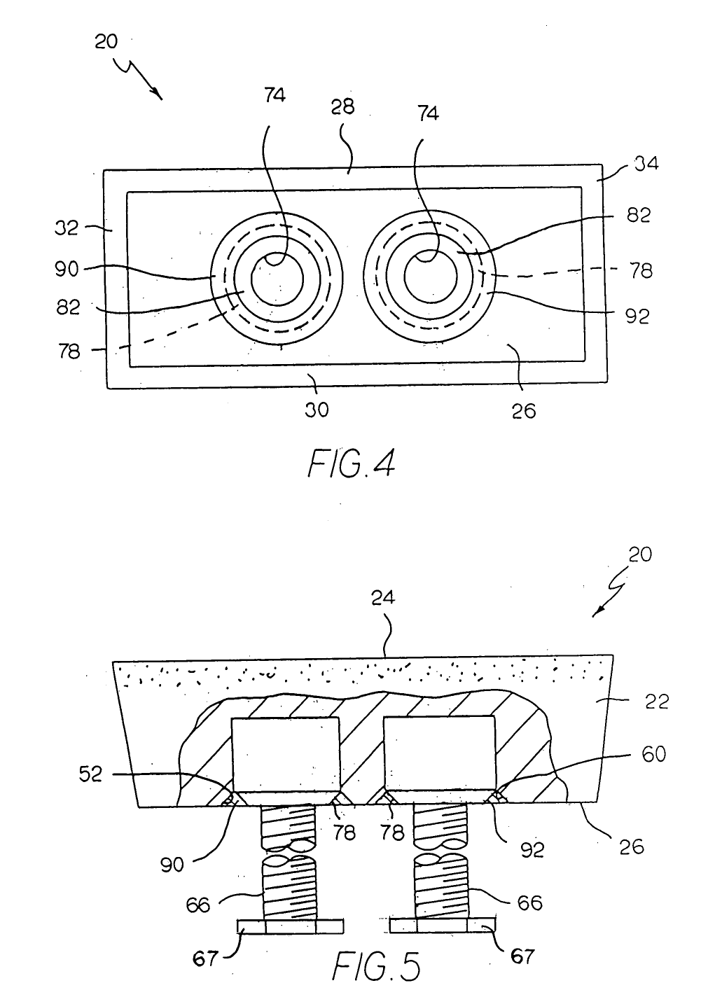

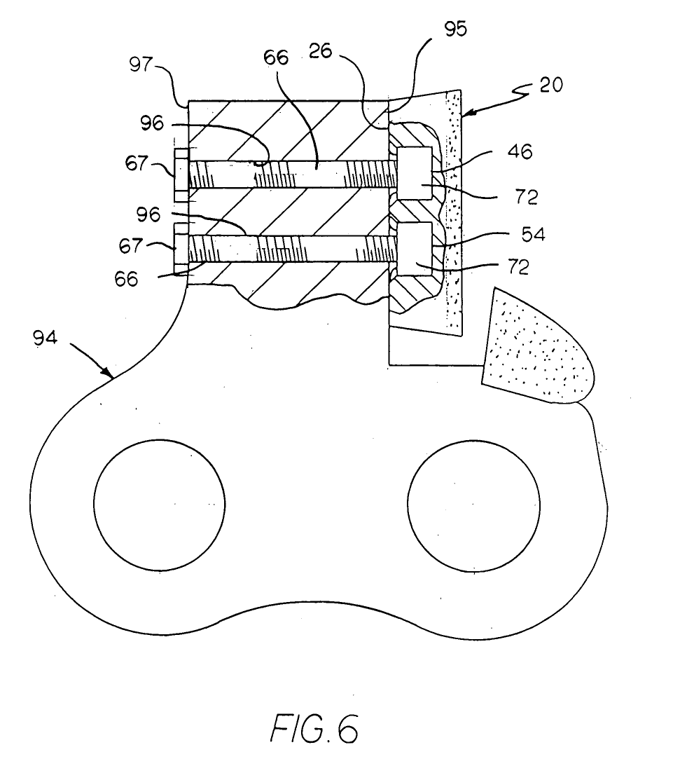

As illustrated in FIGS. 5 and 6, each one of the recesses (46 and 54) receives a receptor 72. The receptors 72 are then affixed as by welding to the hammer tip body 22. In this regard, the weld bead 90 for the receptor in the one recess 46 is located in the volume defined by the chamfer 78 in the receptor 72 and the frusto-conical mouth 52 of the recess 46. In like fashion, the weld bead 92 for the receptor in the other recess 54 is located in the volume defined by the chamfer 78 in the receptor 72 and the frusto-conical mouth 60 of the recess 54. At this point, the hammer tip 20 looks like the structure illustrated in FIG. 4 wherein the receptors 72 are affixed to the hammer tip body 22 without the threaded bolts 66 being received by the receptors.

Referring to FIG. 6, in order to affix the hammer tip 20 to the hammer 94, the hammer tip 20 must be positioned so that the bottom surface 26 of the hammer tip body 22 is adjacent to (or in contact with) a mounting surface 95 on the hammer 94. The threaded bores 74 in the receptors 72 must be in alignment with the bores 96 that pass through the hammer body. Once the threaded bores 74 in the receptors 72 are in alignment with the bores 96, the threaded bolts 66 pass through the bores 96 and engage the threaded bores 74. The threaded bolts 66 are then threaded into the threaded bores 74 until the heads 67 engage the surface 97 of the hammer 94 opposite the mounting surface 95. As the threaded bolts 66 are threaded further into the threaded bores 74 the hammer tip 20 is drawn into tight engagement with the hammer 94 with the result being that the hammer tip 20 is securely affixed to the hammer 94.

It can be appreciated that the entire structure of the receptor assembly 64 including the receptors 72 and substantially all of the threaded bolts 66 are protected from any wear due to impingement from the material that the hammer tip impinges. In this regard, the elongate shank or body of each one of the threaded bolts 66 is contained within its corresponding bore 96 of the hammer 94 and in the threaded bore 74 of its corresponding receptor 72 so that these portions of the threaded bolts 66 do not experience any wear due to impingement. The head 67 of each one of the bolts 66 is held tightly against surface 97 of the hammer 94. This location on the hammer 94 does not experience much impingement from the material impinged by the hammer 94. By protecting the receptor assembly 64 in this fashion, the useful life of the hammer tip 20 has been increased over the useful life of the prior art hammer in which the hammer tip is bolted to the hammer body so that the bolt heads (which are located on the forward face of the hammer tip) are exposed to erosive wear. The increase in useful life is due to the absence (or significant reduction) of erosive wear due to material impingement on the structure (e.g., the bolt heads in the prior art) that connects the hammer tip to the hammer.

It should be appreciated that the present embodiment also protects the integrity of the connection between the hammer tip and the hammer during the operation of the hammer. It should be appreciated that during the operation of the hammer, the hammer tip is subjected to a variety of forces such as, for example, impact forces from many directions that result in twisting forces, rotational forces and torque forces being exerted on the hammer tip. These kinds of forces challenge the integrity of the connection between the hammer tip and the hammer.

In the past, prior art hammer tips have used bolts that pass through bolt holes in the forward face of the hammer tip to connect the hammer tip to the hammer. In such a structure, it is typical that the bolt head is received within a corresponding countersunk bole hole in the hammer bit. In order for the countersunk bolt hole to receive the bolt head, there must be some gap between the bolt head and the countersunk bolt hole.

During operation, there are a wide variety of forces that can act on the hammer tip so as to cause the bolt head to vibrate against the bolt hole in the hammer tip thereby enlarging (or peening) the bolt hole. As can be appreciated, the gap between the bolt head and the countersunk bolt hole increases as the countersunk bolt hole enlarges. As the gap increases in size, the extent of the vibration between the bolt head and the countersunk bolt hole also increases, and can increase to such an extent that the bolt shears. As can be appreciated, when the bolt shears, the integrity of the connection between the hammer tip and hammer diminishes so that the hammer tip may very well become separated from the hammer.

It has also been the case that countersunk bolt holes in the forward face of the hammer tip, as well as the bolt heads received therein, experience erosive wear due to the impingement of the material on the surface of the bolt head and the surfaces that define the countersunk bolt hole. As these surfaces wear, the gap between the bolt head and the countersunk bolt hole increases in size. As mentioned above, this increases the extent of vibration which increases the potential for the bolt to shear.

The present invention protects against the potential for such types of wear on the bolt hole due to peening and erosion, as well as erosive wear on the bolt head, because there is no bolt hole in the forward face of the hammer tip that receives the bolt head of the bolt. This means that there is no structure against which the bolt head can easily vibrate so as to increase the gap between the bolt head and the countersunk bolt hole and thereby increase the extent of the vibration that can result in the shearing of the bolt. In like fashion, there is no exposure of the connection between the hammer tip and hammer to erosive wear which can increase the gap between the bolt head and the countersunk bolt hole.

Instead, in the present embodiment, the distal end of the bolt is received within the threaded bore of a receptor whereby there is no relative movement between the receptor and the bolt because there is no gap between the threaded bore and the threaded member. In addition, the connection between the threaded member and threaded bore is in the interior of the hammer tip and does not experience erosive wear, and thus, does not create any gap between the threaded member and the threaded bore.

Also, the bolt head 67 is drawn tightly against the surface 97 of the hammer 94 so that there is no structure for the bolt head 67 to vibrate against thereby enlarging this structure. It should also be appreciated that even if there would be a countersunk bolt hole in the rear face of the hammer wherein the bolt head is received within this countersunk bolt hole, the forces exerted at the rear face of the hammer are not as large as those exerted on the front face. Further, the rear face of the hammer tip does not experience any degree of erosive wear.

It can therefore be seen that the present invention does not provide structure (e.g., a bolt head that is received in a countersunk bolt hole) that is susceptible to enlargement through peening due to the vibration of the bolt.

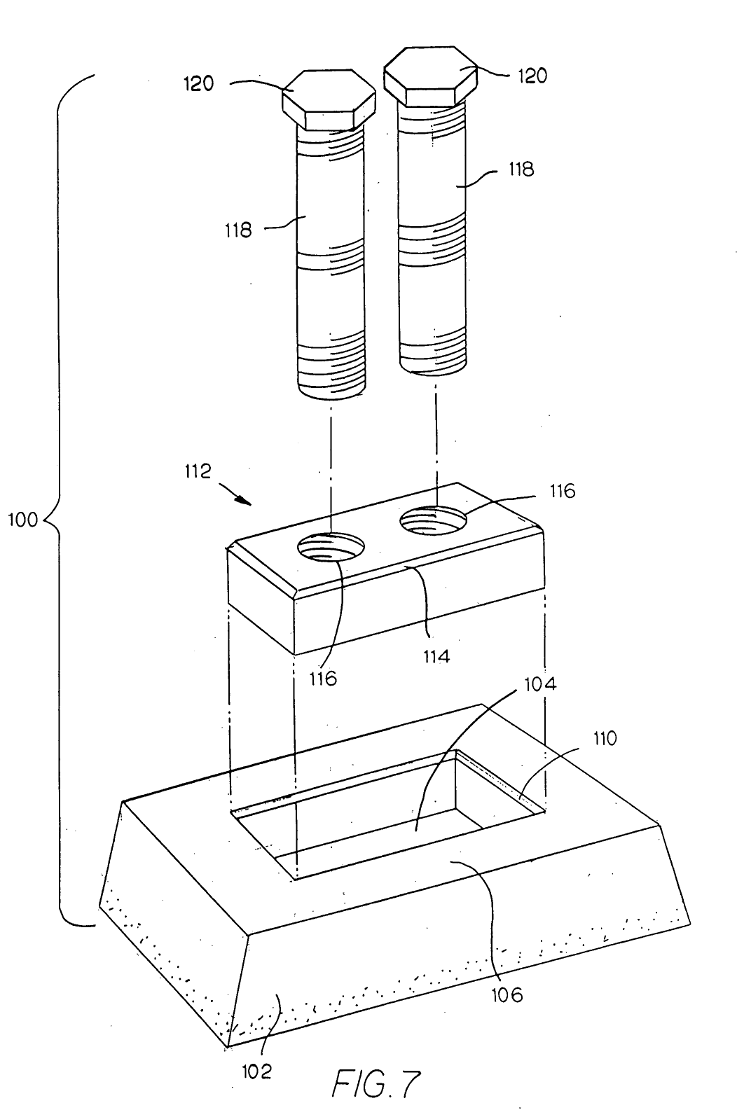

Referring to FIG. 7, there is illustrated therein a second specific embodiment of the hammer tip designated by bracket 100. The hammer tip 100 has a hammer tip body 102 that contains a single cast-in recess 104 in the bottom surface 106 thereof. The cast-in recess 104 presents a generally rectangular (or hexahedron or multi-sided) configuration and includes a bevel 110 at the periphery thereof. The hammer body 102 also presents a wear-resistant portion adjacent its top surface in a fashion like that in the specific embodiment of FIG. 1.

The cast-in recess 104 receives a generally solid rectangular (or hexahedron) receptor generally designated as 112. The geometry of receptor 112 corresponds to the geometry of the recess 104. The receptor 112 has a bevel 114 at its periphery. The receptor 112 is affixed (such as by welding) at its periphery to the bottom surface 106. The receptor 112 contains a pair of threaded bores 116 wherein each threaded bore 116 receives a threaded bolt (or threaded member) 118.

The mounting of the hammer tip 100 to the hammer is substantially the same as the mounting of the hammer tip 20. More specifically, the hammer tip body 102 is positioning on the mounting face so that the threaded bores 116 in the receptor 112 are in alignment with the bores that pass through the hammer. The threaded bolts 118 are then passed through the bores in the hammer and threaded into the threaded bores 116 so as to fasten the hammer tip 100 to the hammer.

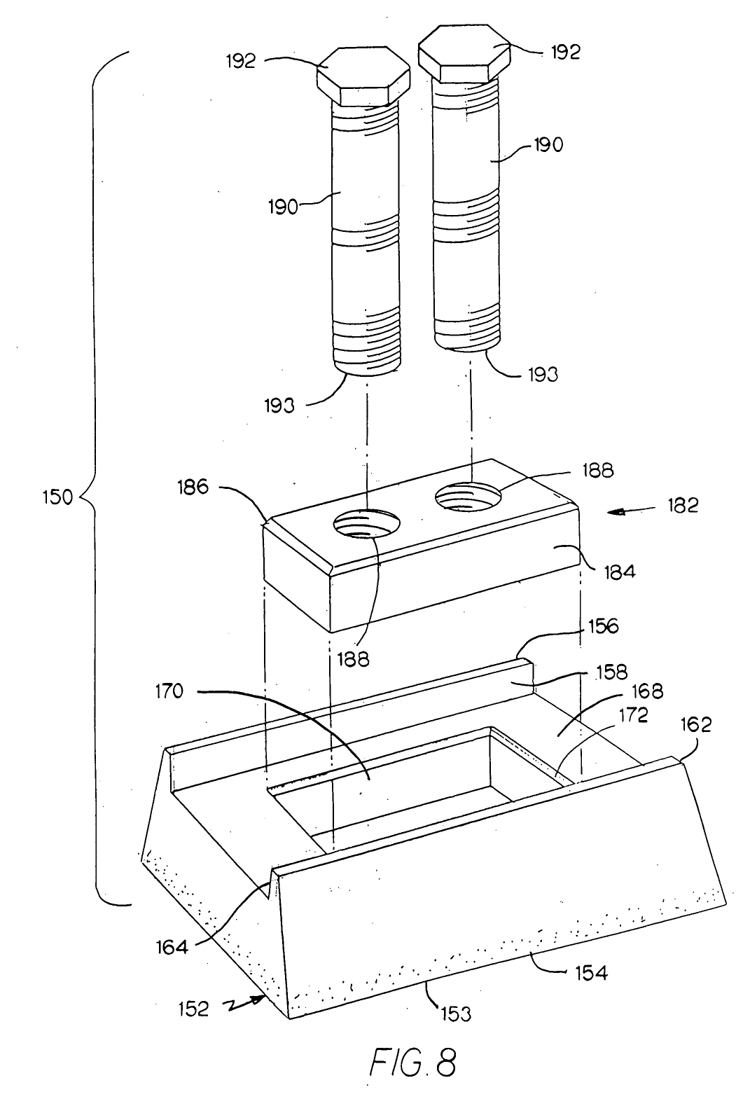

FIG. 8 illustrates still another embodiment of the hammer tip as shown by bracket 150. Hammer tip 150 has a hammer tip body generally designated as 152 that contains a single cast-in recess 170 in the bottom surface 168 thereof. The cast-in recess 174 presents a generally rectangular (or hexahedron or multi-sided) configuration and includes a bevel 172 at the periphery thereof. The hammer body 152 also presents a wear-resistant portion 154 adjacent its top surface in a fashion like that in the specific embodiment of FIG. 1.

The hammer body 152 further includes a pair of integral flanges (156 and 162) that extend in a rearward direction from the front face 153 of the hammer body 152. These flanges 156 and 162 extend from and run along the longitudinal edges of the hammer body 152. Flange 156 has an interior surface 158 and flange 162 has an interior surface 164.

The cast-in recess 170 receives a generally solid rectangular (or hexahedron) receptor generally designated as 182. The geometry of receptor 182 corresponds to the geometry of the recess 170. The receptor 182 has a bevel 186 at its periphery. The receptor 182 is affixed (such as by welding) at its periphery to the bottom surface. The receptor 182 contains a pair of threaded bores 188 wherein each threaded bore 188 receives a threaded bolt (or threaded member) 190. The threaded member 190 has a bolt head 192 at one end and has an opposite distal end 193.

The mounting of the hammer tip 150 to the hammer is substantially the same as the mounting of the hammer tip 20 to the hammer 94. More specifically, the hammer tip body 152 is positioning on the mounting face so that the threaded bores 188 in the receptor 182 are in alignment with the bores that pass through the hammer. The threaded bolts 190 are then passed through the bores in the hammer and threaded into the threaded bores 188. As the bolts 190 are tightened the bolt heads 192 are pulled tightly against the corresponding surface of the hammer so as to tightly secure the hammer tip to the hammer. As can be appreciated, the tighter the bolts are tightened, the tighter the connection between the hammer tip and the hammer.

It should also be appreciated that the interior surfaces (158 and 164) of the flanges 156 and 162, respectively, are proximate to the corresponding surfaces of the hammer.

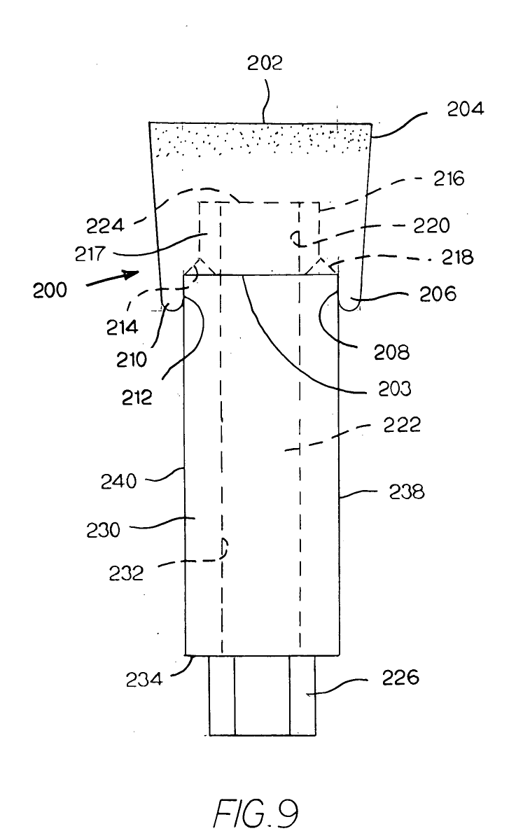

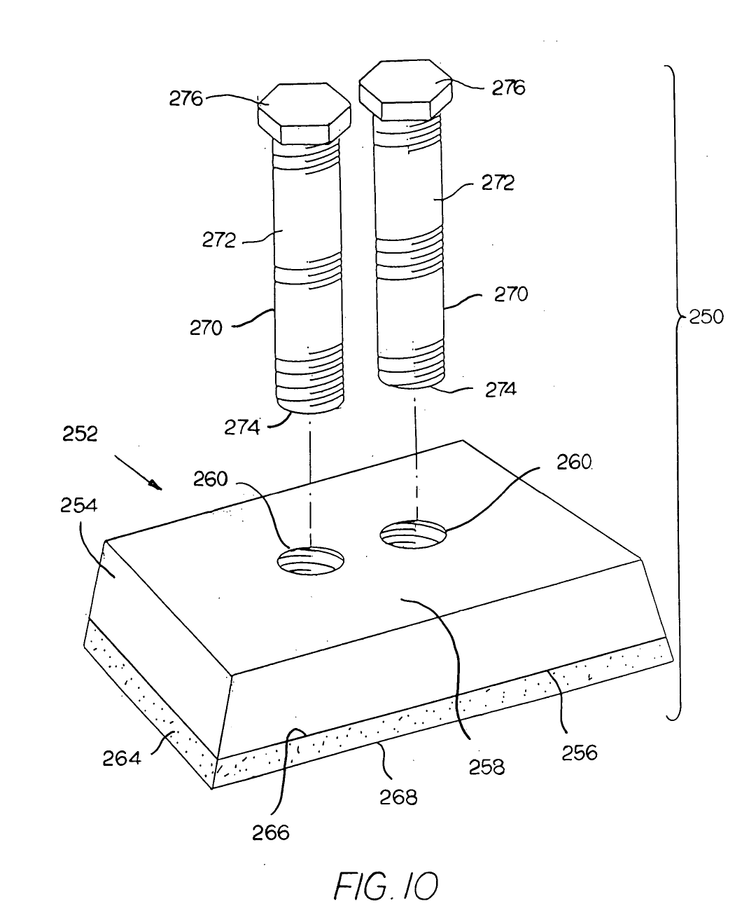

FIG. 9 illustrates still another specific embodiment of a hammer tip generally designated as 200. The structure of hammer tip 200 is like the structure of hammer tip 20, except that hammer tip 200 includes a pair of integral flanges (206,210).

More specifically, hammer tip 200 has a forward face 202 and a rearward face 203. The hammer tip 200 has a wear-resistant portion 204 adjacent the forward face 202 thereof. The hammer tip 200 further has a pair of flanges (206 and 210) that exerted in a rearward direction from the rearward face 203. These flanges (206, 210) run along the longitudinal edges of the hammer tip 200. Flange 206 has an interior surface 208. Flange 210 has an interior surface 212.

The hammer tip 200 contains a pair of cast-in recesses 216 that each have a beveled portion 214 thereabout. Each cast-in recess 216 receives a receptor 217 wherein the receptor 217 contains a threaded bore 220 and a beveled portion 218 that surrounds the bore 220.

The hammer 230 has a pair of bolt holes 232 that pass therethrough. The hammer tip 200 connects (or attaches) to the hammer 230 in the same way as does hammer tip 20 connect to hammer 94. In this regard, a threaded member 222 passes through each bolt hole 232 and is received within the threaded bore 220 of the corresponding receptor 217. The threaded member 222 is tightened so as to securely attach the hammer tip 200 to the hammer 230. The threaded member 222 has a bolt head 226 that draws tightly against the rear surface 234 of the hammer 230.

The hammer 230 has opposite side surfaces 238 and 240. When the hammer tip 200 is drawn tightly against the hammer 230, interior surface 208 of flange 206 is adjacent to surface 238 and interior surface 212 of flange 210 is adjacent to surface 240. Because of the close proximity (or even contact) of the interior surfaces (208 and 212) of the flanges (206 and 210), the integrity of the connection between the hammer tip 200 and the hammer 230 is enhanced.

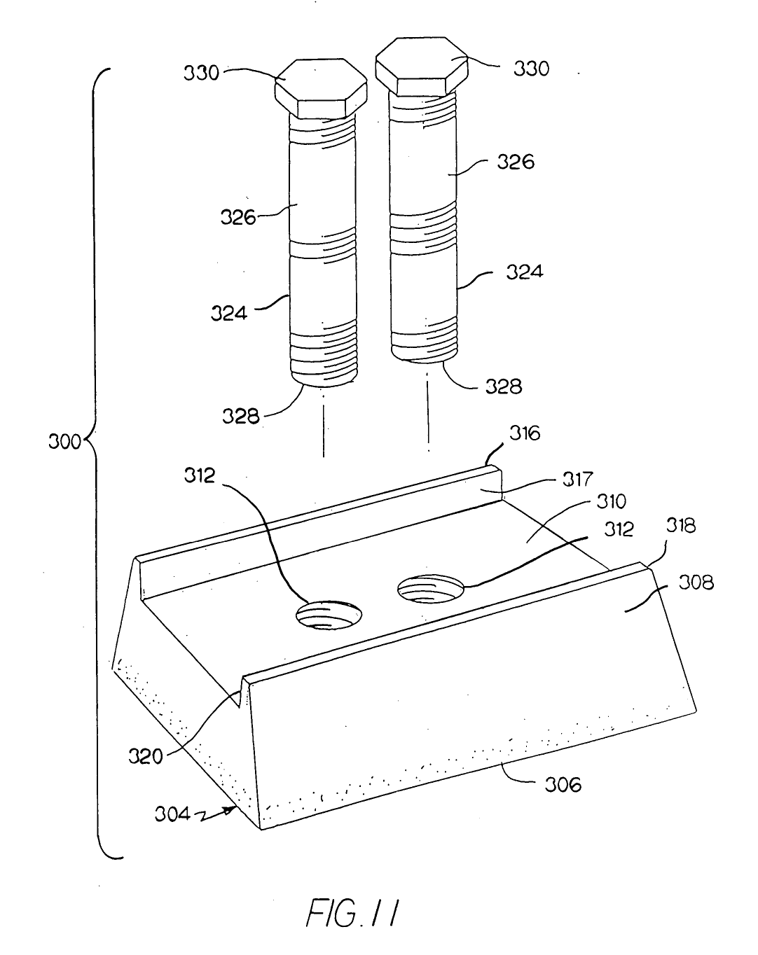

Referring to FIG. 10, there is illustrated a fourth specific embodiment of the hammer tip assembly designated by bracket as 250. The hammer tip assembly 250 includes a hammer tip 252 that has a hammer tip body (or hammer tip substrate) 254 that has a forward or top surface 256 and a bottom or rearward surface 258. The hammer tip body 254 contains a pair of threaded bores 260 therein. While two threaded bores are shown, applicant contemplates that any appropriate number of threaded bores may be contained in the hammer tip body depending upon the specific application. Further, the threaded bores 260 may either stop short of the forward surface 256 of the hammer tip body 254 or extend all the way to the forward surface.

The hammer tip 250 further includes a wear-resistant member 264 that presents a rearward surface 266 and a forward surface 268. The wear-resistant member 264 at its reward surface 266 is brazed or otherwise affixed in some fashion to the forward surface 256 of the hammer tip body 254. The hammer tip assembly 250 further includes a pair of threaded member 270 wherein each threaded member 270 has a threaded shank 272 with a distal end 274 and a head portion 276 at the end opposite from the distal end 274.

The hammer tip 252 typically is attached to a hammer that has a pair of bolt holes that pass therethrough. The hammer tip 252 connects (or attaches) to the hammer in the same way as does hammer tip 20 connect to hammer 94. In this regard, the threaded members 270 passes through their respective bolts holes and are received within their respective threaded bore 260 in the hammer tip body 254. The threaded members 260 are tightened so as to securely attach the hammer tip 252 to the hammer. Each one of the threaded members 270 has a bolt head 276 that draws tightly against the rear surface of the hammer.

It should be appreciated that the portion of the threaded member 270 that is axial forward of the head 276 is contained within the mass of the hammer tip body so that this portion does not experience any wear due to erosion or impingement of the material that is being impacted or worked on by the hammer tip. Since the wear-resistant member 264 covers the forward surface of the hammer tip body, this portion of the threaded member is protected whether the threaded bore stops short of or extends to the forward surface.

Referring to FIG. 11, there is illustrated another specific embodiment of the hammer tip assembly as designated by bracket 300. The hammer tip assembly 300 includes a hammer tip 304 that has a hammer tip body (or hammer tip substrate) 308 and a wear-resistant member 306. The wear-resistant member 306 is affixed such as, for example, by brazing to the forward surface of the hammer tip body 308.

The hammer tip body 308 contains a pair of threaded bores 312 therein. While two threaded bores are shown, applicant contemplates that any appropriate number of threaded bores may be contained in the hammer tip body 308 depending upon the specific application. The threaded bores 312 may terminate short of the forward surface of the hammer tip body 308 or may extend all the way to the forward surface.

The hammer tip body 308 further includes a pair of integral flanges (316, 318) that extend in a rearward direction from the front face of the hammer tip body 308. These flanges (316, 318) extend from and run along the longitudinal edges of the hammer tip body 308. Flange 316 has an interior surface 317 and flange 318 has an interior surface 300.

The hammer tip assembly 300 further includes a pair of threaded members 324. Each threaded member 324 has a threaded shank 326 that has an end 328 and an opposite end at which there is a head 330.

Generally speaking, the hammer tip 304 is attached to a hammer that contains a pair of bolt holes (or bores) that pass therethrough. The hammer tip 304 connects (or attaches) to the hammer in the same way as hammer tip 252 connects to the hammer in that the threaded members 324 pass through their respective bolt holes and are received within their respective threaded bores 312. The threaded members 324 are tightened so as to securely attach the hammer tip 304 to the hammer. The head 330 draws tightly against the rear surface of the hammer as the threaded members 324 are tightened.

The hammer has opposite side surfaces. When the hammer tip 304 is drawn tightly against the hammer, interior surface 317 of flange 316 is adjacent to its corresponding surface of the hammer and interior surface 320 of flange 318 is adjacent to its corresponding surface of the hammer. Because of the close proximity (or even contact) of the interior surfaces of the flanges, the integrity of the connection between the hammer tip and the hammer is enhanced.

It can thus be seen that the present invention provides an improved hammer tip, as well as a hammer that uses the improved hammer tip. It can also be seen that the present invention provides an improved detachable hammer tip, as well as a hammer that uses such a hammer tip. It can also be seen that the present invention provides an improved hammer tip, as well as a hammer that uses the hammer tip, wherein the structure that secures the hammer tip to the hammer are protected from wear due to the impingement of the material.

The patents and other documents identified herein are hereby incorporated by reference herein. Other embodiments of the invention will be apparent to those skilled in the art from a consideration of the specification or a practice of the invention disclosed herein. It is intended that the specification and examples are illustrative only and are not intended to be limiting on the scope of the invention. The true scope and spirit of the invention is indicated by the following claims.

What is claimed is:

1. A hammer tip for use in conjunction with a hammer, the hammer tip comprising:
a hammer tip body having a wear-resistant top surface and a bottom surface, the hammer tip body containing a hammer tip recess opening in the bottom surface;
a receptor containing a receptor bore; and
the receptor being affixed within the hammer tip recess.

2. The hammer tip of claim 1 further including a plurality of the hammer tip recesses and a plurality of the receptors, and wherein each one of the hammer tip recesses receives one of the receptors.

3. The hammer tip of claim 1 further including a threaded member, and the threaded member being received within the receptor bore.

4. The hammer tip of claim 1 wherein the hammer tip recess is cylindrical in shape, and the receptor presents a cylindrical geometry.

5. The hammer tip of claim 1 wherein the hammer tip recess is multi-sided in shape, and the receptor exhibits a solid geometry corresponding to the geometry of the hammer tip recess.

6. The hammer tip of claim 1 wherein the receptor contains a plurality of the receptor bores.

7. The hammer tip of claim 6 further including a plurality of threaded members, and wherein each one of the receptor bores receiving a threaded member.

8. The hammer tip of claim 1 wherein a pair of opposite flanges extend from the bottom surface.

9. A hammer tip for use in conjunction with a hammer, the hammer tip comprising:
a cast hammer tip body having a top surface and a bottom surface;
the cast hammer tip body having a wear-resistant portion beginning at and extending toward the bottom surface, and the cast hammer tip body having a cast recess opening in the bottom surface;
a receptor containing a receptor bore;
a threaded member being received within the receptor bore; and
the receptor being within the hammer tip recess whereby at least a portion of the threaded member projects past the bottom surface of the hammer tip body.

10. The hammer tip of claim 9 further including a plurality of the hammer tip recesses and a plurality of the receptors, and wherein each one of the hammer tip recesses receives one of the receptors.

11. The hammer tip of claim 9 wherein the receptor contains a plurality of the receptor bores, and further including a plurality of the threaded members, and wherein each one of the receptor bores receiving a threaded member.

12. The hammer tip of claim 9 wherein a pair of flanges extend from the bottom surface.

13. A hammer comprising:
a hammer body containing a mounting surface and a bore in communication with the mounting surface;
a hammer tip comprising a hammer tip body having a wear-resistant top surface and a bottom surface wherein the bottom surface is adjacent to the mounting surface of the hammer body, the hammer tip body containing a hammer tip recess opening in the bottom surface;
a receptor containing a receptor bore, and the receptor being affixed within the hammer tip recess;
a threaded member passing through the bore in the hammer body and being received by the receptor bore so as to attach the hammer tip to the hammer body.

14. The hammer of claim 12 further including a plurality of the hammer tip recesses and a plurality of the receptors, and wherein each one of the hammer tip recesses receiving one of the receptors.

15. The hammer of claim 12 wherein the receptor contains a plurality of the receptor bores, and further including a plurality of the threaded members, and wherein each one of the receptor bores receiving a threaded member.

16. A hammer tip for use in conjunction with a hammer, the hammer tip comprising:
a wear-resistant top surface and a bottom surface; and
wherein the bottom surface contains a threaded bore adapted to receive a threaded member.

17. The hammer tip of claim 16 wherein the hammer tip body comprising a hammer tip substrate and a wear-resistant member, and the wear-resistant member being affixed to the hammer tip substrate.

18. The hammer tip of claim 16 wherein the hammer tip substrate contains a plurality of the threaded bores.

19. The hammer tip of claim 16 wherein a plurality of flanges extend from the bottom surface of the hammer tip.

20. The hammer tip of claim 16 wherein at least one flange extends from the bottom surface of the hammer tip.
